(19) United States
(12) Patent Application Publication
(10) Pub. No.: US 2025/0038408 A1
(43) Pub. Date: Jan. 30, 2025

(54) LOOP-DIPOLE, DUAL-WIDEBAND ANTENNA DESIGN

(71) Applicant: Meta Platforms Technologies, LLC, Menlo Park, CA (US)

(72) Inventor: Katherine Coles, San Jose, CA (US)

(21) Appl. No.: 18/358,916

(22) Filed: Jul. 25, 2023

(51) Int. Cl. H01Q 5/48; H01Q 7/00

(52) U.S. Cl. CPC H01Q 5/48; H01Q 7/00

(57) ABSTRACT

A system may include a loop antenna and a dipole antenna that includes at least two dipole arms. Each of the at least two dipole arms may be electrically connected to the loop antenna. Within the system, the loop antenna may be a balun for the dipole antenna. In some cases, the electrical connection between the loop antenna and the arms of the dipole antenna may create a combined loop-dipole, dual-wideband antenna. The combined antenna may be tunable using a tuner that is electrically connected to the combined antenna. Various other mobile electronic devices, apparatuses, and methods of manufacturing are also disclosed.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 illustrates an example embodiment of a virtual reality headset that includes at least one of the antenna designs described herein.

FIGS. 2A and 2B illustrate example embodiments of a loop-dipole, dual-wideband antenna as described herein.

FIGS. 3A-3C illustrate alternative example embodiments of a loop-dipole, dual-wideband antenna as described herein.

FIGS. 4A-4B illustrate example embodiments of a loop-dipole, dual-wideband antenna that may be tuned as described herein.

FIG. 5 illustrates an alternative example embodiment of a loop-dipole, dual-wideband antenna as described herein.

FIG. 6 illustrates an example chart showing efficiency of a loop-dipole, dual-wideband antenna as described herein.

FIGS. 7A and 7B illustrate example charts showing S-parameters and efficiency, respectively, of a loop-dipole, dual-wideband antenna as described herein.

FIGS. 8A-8C illustrate example radiation patterns for a loop-dipole, dual-wideband antenna at different frequencies as described herein.

FIG. 9 is an illustration of exemplary augmented-reality glasses that may be used in connection with embodiments of this disclosure.

FIG. 10 is an illustration of an exemplary virtual-reality headset that may be used in connection with embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The present disclosure is generally directed to an improved antenna design that implements elements of both loop antennas and dipole antennas. In one embodiment, the antenna designs described herein may implement a loop antenna as a balun (balancing unit) for an associated dipole antenna.

In some wireless devices that implement antennas, wireless engineers have typically focused on a specific, initial frequency when designing those antennas. In the case of WiFi antennas, for example, the engineers may focus on an initial frequency (e.g., 2.4 GHz), while allowing secondary harmonics to occur wherever they happen to lie (e.g., between 6-7 GHz for WiFi). This range of 6-7 GHz for the secondary harmonics, however, may be insufficiently large to allow for full dual-band WiFi operation of the wireless device.

The embodiments described herein, including those directed to a loop-dipole, dual-wideband antenna, may expand the range of the antenna's secondary harmonics to between 5-6 GHz or between 5-7 GHz. Moreover, the embodiments described herein may also make the secondary harmonics more tunable. As such, the loop-dipole, dual-wideband antenna provided herein may operate at an initial frequency as well as a tunable, secondary frequency that may operate at previously unachievable frequencies below 6 GHz. This antenna design may include a loop antenna and may include two (or more) dipole arms that extend away from the loop antenna. The dipole arms may then be electrically connected to an antenna feed and operated within an electronic device.

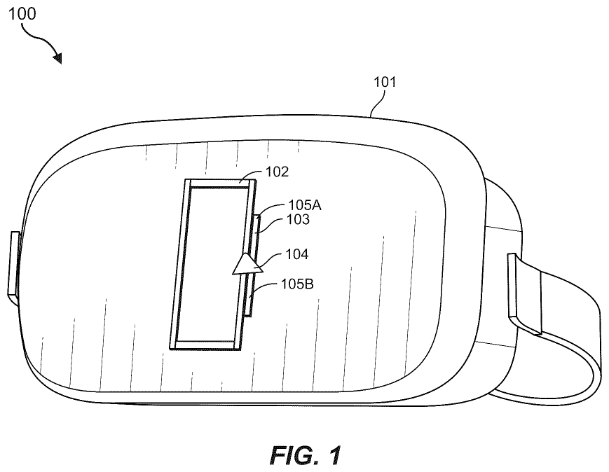

While other antenna designs may implement a balun between the antenna feed and a dipole antenna, in the antenna designs described herein, the loop antenna itself may act as a balun and, as such, may transition electrical currents from being unbalanced to being balanced. Moreover, the antenna design described herein may reduce complexity, may reduce the number of components in the wireless device, and may provide tunability and lower range overall for the antenna. These embodiments will be described in greater detail below with regard to FIGS. 1-10.

Features from any of the embodiments described herein may be used in combination with one another in accordance with the general principles described herein. These and other embodiments, features, and advantages will be more fully understood upon reading the following detailed description in conjunction with the accompanying drawings and claims.

FIG. 1 generally illustrates a virtual reality (VR) headset 100. Although many of the antenna embodiments described herein are described in relation to a VR headset, it will be recognized that these antenna designs may be used with substantially any electronic device that uses an antenna, including augmented reality (AR) devices, smartwatches, smartphones, laptops, tablets, or other electronic devices. The VR headset 100 may include multiple different hardware and software modules that work together to create a virtual environment for a user. The user may view an immersive display that effectually surrounds the user and provides an interactive environment in which the user may perform myriad different tasks. Many of these tasks may involve outside communication with other computer systems or devices.

In some cases, the VR headset 100 may implement a WiFi antenna (or multiple WiFi antennas), along with potentially other antennas such as Bluetooth, global positioning system (GPS), cellular, near-field communication (NFC), or other antennas. The antenna designs herein will often be described in association with WiFi antennas, although these antenna designs may work with substantially any antenna architecture or antenna type. Some dipole antennas use balancing units or “baluns” to balance a connection between unbalanced electrical systems (e.g., systems where power flows from an unbalanced component or line to a balanced line). In short, the balun may be used to balance unbalanced electrical systems. In some cases, malfunctions may occur if balanced antennas (e.g., dipoles or antennas with similar forms) are directly fed with an unbalanced feed line (e.g., a coaxial cable). A balun may convert the unbalanced signal to a balanced signal, enabling the balanced dipole antenna with an unbalanced feed line such as coax.

In the embodiments herein, and as shown in FIG. 1, a VR headset 101 or other electronic device may include a loop antenna 102 and a dipole antenna 103 that includes at least two dipole arms 105A/105B. In this embodiment, each of the dipole arms 105A/105B may be electrically connected to the loop antenna 102. By arranging the antenna architecture in this manner, the loop antenna 102 may function as or may itself be a balun for the dipole antenna 103. In general, for a dipole antenna to operate properly, each arm of the antenna should have in-phase electrical current. A coaxial cable has both an inner connector wire and an outer conductor, and a perfectly balanced line will have equal current on the center pin and the outer ground conductor. Because some current from the antenna could travel back on the outer conductor, this type of coaxial cable is unbalanced. To ensure that no current travels back from the antenna onto the outer conductor of the coaxial cable, a balancing unit will aim to prevent antenna currents from flowing to the outer conductor, thereby providing balanced currents to the dipole arms from an unbalanced line.

The loop antenna 102, in the antenna designs shown and described herein with reference to FIG. 1, provides a wireless architecture that functions as a balun for the dipole antenna 103. In such embodiments, when an unbalanced feed is applied to the dipole antenna 103, the loop antenna 102 receives the current for the unbalanced portion of the antenna feed and, as a result, that current from the unbalanced portion is prevented from going to the dipole antenna. Moreover, the current transferred to the loop antenna is effectively used by the loop antenna 102 to provide additional bandwidth. Indeed, in at least some embodiments, the loop antenna 102 may provide bandwidth from 5-7 GHz, while other antennas may only provide second harmonic bandwidth between 6.5-7 GHz. This additional bandwidth may allow fewer antennas to be used within an electronic device, thereby freeing up more space.

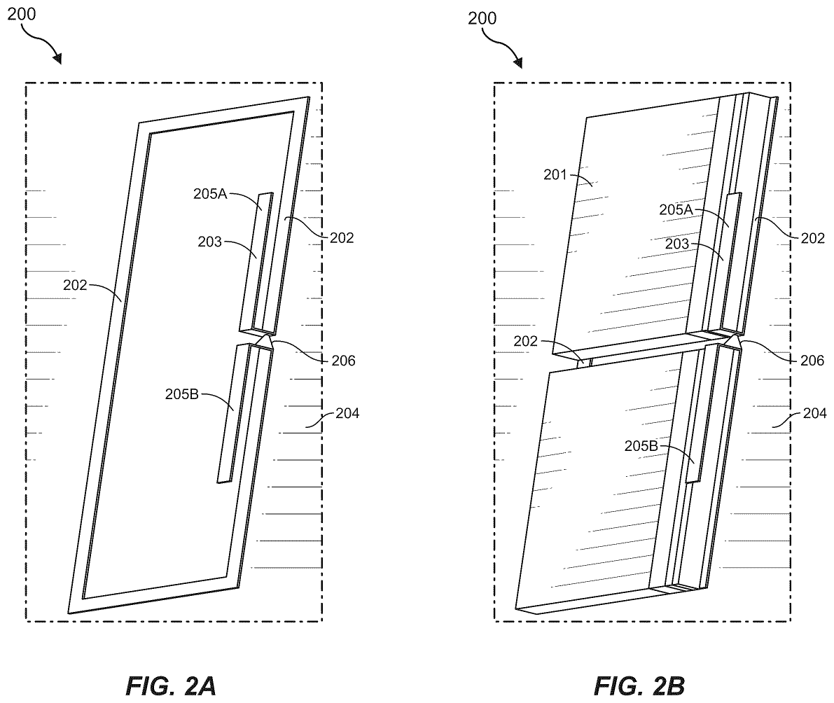

FIGS. 2A and 2B illustrate embodiments of a combined loop and dipole antenna 200. In FIG. 2A, the combined antenna 200 is illustrated without a dielectric in place, while FIG. 2B illustrates the same combined antenna 200 with a dielectric 201 in place. The dielectric 201 may act as an electrical insulator, insulating the combined antenna 200 from other components within the electronic device 204 that houses the antenna. The combined antenna 200 may include a dipole antenna 203 having two arms, 205A and 205B, and a loop antenna 202.

In some cases, an antenna feed 206 (or other electrical connection) between the loop antenna and the two arms of the dipole antenna 205A/205B may combine to create a loop-dipole, dual-wideband antenna. This combined antenna may operate at approximately 2.4 GHz and between 5-7 GHZ, or above or below those values with tuning. The dipole arms 205A/205B may extend upward in three dimensions away from the loop antenna 202, which lies on a planar surface. The dipole arms 205A/205B, after extending upward, may bend back over the loop antenna 202 and may lie on top of and above at least a portion of the loop antenna.

In some cases, the dielectric 201 may be formed into (or inserted between) the gap that lies between the dipole antenna arms 205A/205B and the loop antenna 202. In some embodiments, holes may be cut into the dielectric to fit around other mechanical or electrical parts of the electronic device in which the combined antenna is used. The holes may vary in size, shape, or number within any given dielectric.

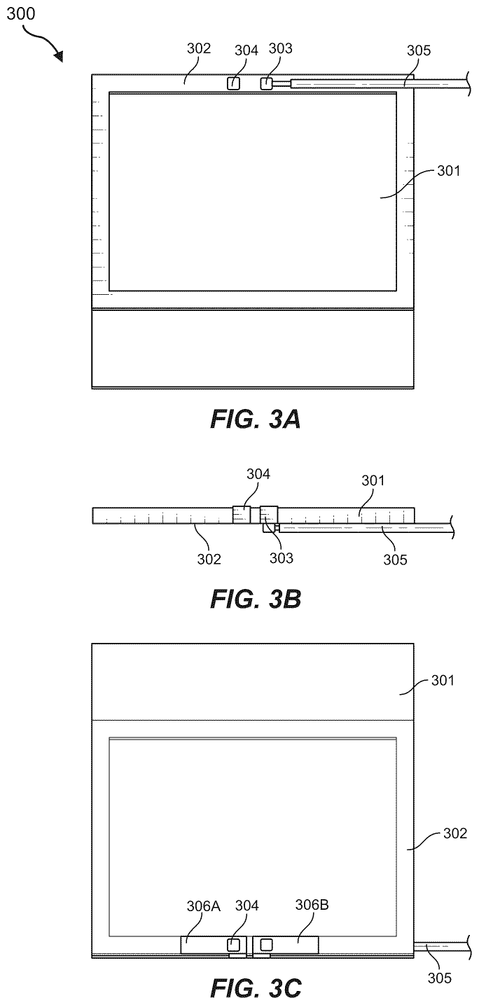

FIGS. 3A, 3B, and 3C illustrate different views of an example embodiment of a combined loop and dipole antenna 300. The combined loop and dipole antenna 300 may include a loop antenna 302 and a dipole antenna 303. The combined antenna 300 may be fed by a coaxial cable 305 or other type of antenna feed. FIG. 3A, for example, illustrates a front view of a combined loop and dipole antenna 300. The loop antenna 302 may loop around the top portion of the dielectric 301 or around other structural elements. The dipole antenna 303 may include an electrical contact that electrically connects a first arm of the dipole antenna to an antenna feed. The dipole antenna may also include a second arm 304 that has a corresponding electrical connection point. As seen in the top view of FIG. 3B and in the bottom view of FIG. 3C, the coaxial cable 305 is electrically connected to the left-side and right-side arms 306A/306B of the dipole antenna 303. As can be seen, the two arms of the dipole antenna 306A/306B lie below the loop antenna 302 and curve outward over the loop antenna away from the antenna feed.

In some cases, the combined loop-dipole, dual-wideband antenna 300 may be tunable. The combined antenna may be tunable using at least one tuner that is electrically connected thereto. In some cases, the tuner is part of an antenna feed. In such cases, the combined antenna may be tunable between 5-7 GHz. This frequency range may represent the available resonance frequencies of the combined antenna. In this manner, the combined antenna's resonance can be tuned independent of the main operating frequency (e.g., 2.4 GHz) to increase bandwidth at the low end of the higher band (i.e., the resonance band, for example, between 5-6 GHz or 5-7 GHz). At least in some cases, this tuning of the loop-dipole may be performed independently of the loop, without impacting the loop resonances.

As can be seen in FIGS. 2A and 2B, as well as in FIGS. 3A-3C, the two dipole arms of the dipole antenna may be electrically connected to the loop antenna along a three-dimensional plane. For example, in FIG. 2A, for instance, the two dipole arms 205A/205B of the dipole antenna 203 are shaped such that at least a portion of the dipole arms extends away from the loop antenna 202. Thus, as can be seen in FIG. 2A, for example, the loop antenna 202 may wrap around and form a rectangular loop. Where the antenna feed 206 electrically connects to the combined loop dipole antenna 200, the dipole portion of the combined antenna extends away from the loop antenna upward for a given length. The arms of the dipole antenna 203 may then bend back toward the loop antenna 202 and may overlap the loop antenna for a specified length.

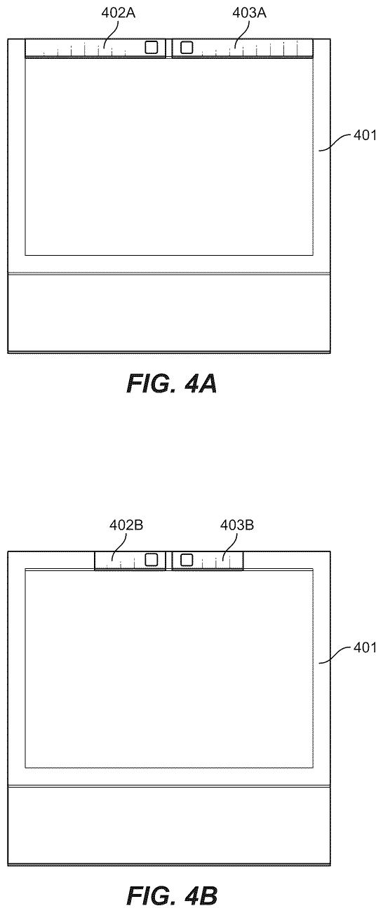

In some cases, the lengths of the overlaps by the dipole antenna arms may vary, as may the length of the dipole antenna that extends away from the loop antenna 202. Thus, for instance, the two dipole arms 205A/205B of the dipole antenna 203 may be shaped such that at least a portion of the dipole arms extends orthogonally along a z-axis away from the loop antenna over a specified length. This length may be shorter than the overlap length. Still further, the dipole antenna arms may bend and extend over the loop antenna for a different specified length. This length may be longer than the length of the orthogonal extension. FIGS. 4A and 4B illustrate embodiments showing how the lengths of the dipole antenna arms may vary, as may the length of the overlap with the loop antenna.

In FIG. 4A, for instance, a combined antenna may include a loop antenna 401 and two dipole arms of a dipole antenna (402A and 403A). These arms may extend along substantially the entire top portion of the loop antenna 401. The dipole arms 402B and 403B of FIG. 4B, however, are relatively shorter when compared to the dipole arms 402A/402B. The shorter dipole arms of FIG. 4B may provide different resonances at different frequencies than the longer dipole arms of FIG. 4A. As such, different length dipole arms may be used across various electronic devices and implementations to provide the desired resonance range (e.g., coverage at 2.4 GHz and 5-7 GHz).

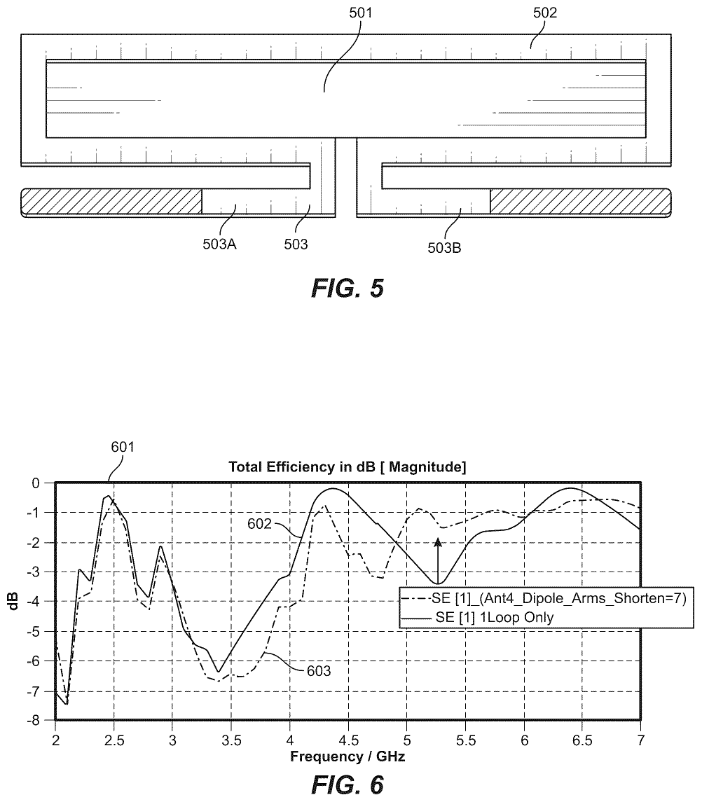

FIG. 5 illustrates an embodiment in which the two dipole arms of a dipole antenna may be electrically connected to a loop antenna along a two-dimensional plane. Thus, in a combined loop-dipole, dual-wideband antenna 501 that includes both a loop antenna 502 and a dipole antenna 503, the dipole arms 503A and 503B may be electrically connected to the loop antenna along a two-dimensional plane. Instead of bending upward and away from the loop antenna orthogonally, and then bending again over the top of the loop antenna, the combined antenna of FIG. 5 is laid out on a flat, two-dimensional surface.

The loop antenna 502 may form a rectangular loop that transitions, in a middle section, to include two arms 503A and 503B of a dipole antenna. These dipole arms may be of differing lengths in different implementations or in different electronic devices. At least in some cases, the two-dimensional combined loop-dipole, dual-wideband antenna 501 may be suited to implementation on a printed circuit board, where the loop antenna 502 and the dipole antenna 503 may be formed using electrical traces. The two-dimensional combined antenna may be installed in substantially any orientation, and any given implementation may include substantially any number of such combined antennas.

At least in some cases, as in the three-dimensional combined antenna described above, the two-dimensional combined antenna may be tunable using a tuner or by changing size or shape aspects of the combined antenna itself. Thus, in some cases, the electrical connection between the loop antenna 502 and the two arms 503A/503B of the dipole antenna 503 may create a combined loop-dipole, dual-wideband antenna that is tunable, specifically in the 5-6 GHz and 5-7 GHz ranges. These frequency ranges may represent secondary harmonics of the combined antenna. These secondary harmonics may be tuned using a tuner that is electrically connected to the combined antenna, or by changing the size, shape, impedance, or other characteristics of the loop antenna 502 and/or the dipole antenna 503, including the size of the dipole arms.

FIG. 6 illustrates a chart 601 that shows a measure of total efficiency for a combined loop-dipole, dual-wideband antenna. Line 602 illustrates the measured efficiency of a loop antenna by itself, while line 603 illustrates the measured efficiency of a combined loop-dipole, dual-wideband antenna. As can be seen, the efficiency of the combined antenna between 5-6 GHz is 2-3 dB higher than the efficiency of the loop antenna alone.

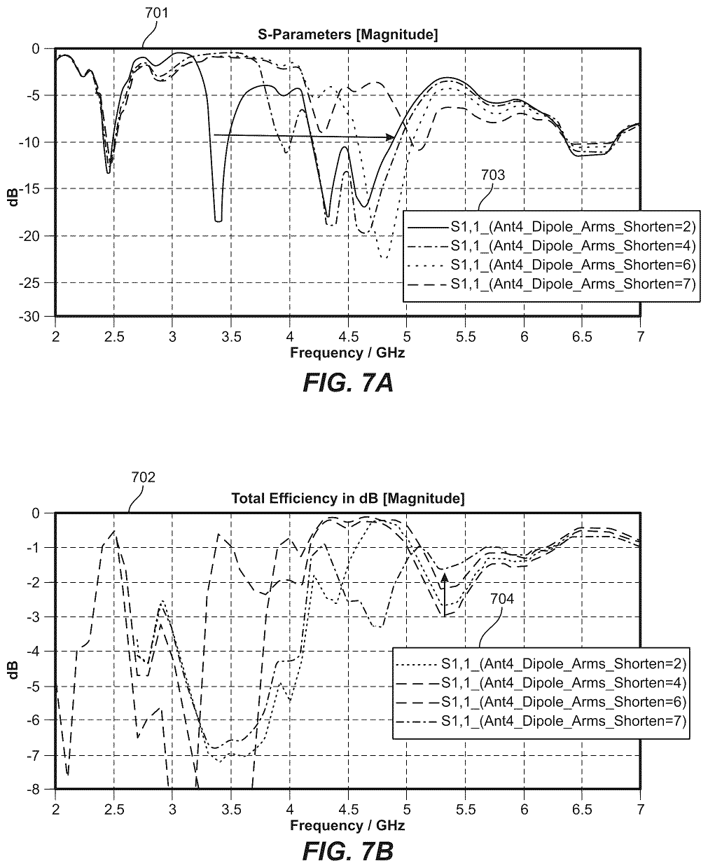

FIG. 7A illustrates a chart 701 showing measured s-parameters for different combined loop-dipole, dual-wideband antennas that have different dipole arm lengths. Although a relatively small amount of differentiation exists between the performance of the various antennas between 5-7 GHz, those antennas 703 having shorter dipole arm lengths appear to be slightly more efficient than antennas having longer dipole arm lengths. FIG. 7B illustrates a chart 702 showing a measurement of total efficiency for the same combined loop-dipole, dual-wideband antenna having the same combinations of dipole arm lengths. Again, between 5-7 GHz, a relatively small amount differentiation exists between the various antennas 704, although those antennas having relatively longer dipole arm lengths appear to be more efficient than antennas having shorter dipole arm lengths.

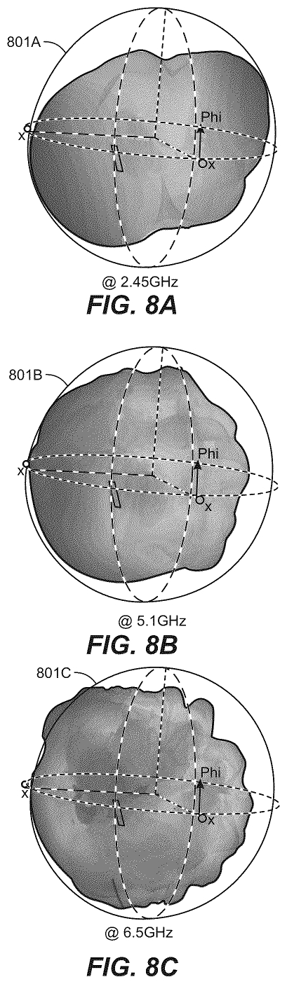

FIGS. 8A-8C illustrate antenna radiation patterns for a combined loop-dipole, dual-wideband antenna. For example, FIG. 8A illustrates an antenna radiation pattern 801A that is based on the combined antenna operating at 2.45 GHz. FIG. 8B illustrates an antenna radiation pattern 801B that is based on the combined antenna operating at 5.1 GHz, while FIG. 8C illustrates an antenna radiation pattern 801C that is based on the combined antenna operating at 6.5 GHz. FIGS. 8B and 8C illustrate how the combined loop-dipole, dual-wideband antenna operates at its secondary harmonic frequencies, and indicates that at those frequencies, the combined antenna provides a wideband radiation pattern that radiates substantially omnidirectionally and with a great amount of power. Accordingly, the combined loop-dipole, dual-wideband antenna embodiments described herein may be implemented to provide a balancing unit to an antenna while simultaneously adding additional lower-spectrum bandwidth between 5-6 GHz. This can increase the tunable range of the loop-dipole antenna, allowing for a loop-dipole antenna to potentially replace other types of antennas that were incapable of providing sufficient bandwidth in the 5-7 GHz region.

In addition to the system described above, a mobile electronic device may be provided. This mobile electronic device may include a loop antenna and a dipole antenna that includes at least two dipole arms. In this mobile device, each of the at least two dipole arms may be electrically connected to the loop antenna. In this manner, the loop antenna may be or may function as a balun for the dipole antenna.

Still further, a corresponding apparatus may also be provided. The apparatus may include a loop antenna and a dipole antenna that includes at least two dipole arms. In the apparatus, each of the at least two dipole arms may be electrically connected to the loop antenna. As such, the loop antenna may be or may function as a balun for the dipole antenna.

### EXAMPLE EMBODIMENTS

Example 1: A system may include a loop antenna and a dipole antenna that includes at least two dipole arms, wherein each of the at least two dipole arms is electrically connected to the loop antenna, and wherein the loop antenna comprises a balun for the dipole antenna.

Example 2: The system of Example 1, wherein the electrical connection between the loop antenna and the at least two arms of the dipole antenna create a combined loop-dipole, dual-wideband antenna.

Example 3: The system of Example 1 or Example 2, wherein the combined loop-dipole, dual-wideband antenna is tunable using at least one tuner that is electrically connected thereto.

Example 4: The system of any of Examples 1-3, wherein the combined loop-dipole, dual-wideband antenna is tunable between 5-7 GHz.

Example 5: The system of any of Examples 1-4, wherein the at least two dipole arms of the dipole antenna are electrically connected to the loop antenna along a two-dimensional plane.

Example 6: The system of any of Examples 1-5, wherein the at least two dipole arms of the dipole antenna are shaped such that at least a portion of the dipole arms extends away from the loop antenna over a specified length and such that at least a portion of the dipole arms bends toward the loop antenna for a different specified length.

Example 7: The system of any of Examples 1-6, wherein the at least two dipole arms of the dipole antenna are electrically connected to the loop antenna along a three-dimensional plane.

Example 8: The system of any of Examples 1-7, wherein the at least two dipole arms of the dipole antenna are shaped such that at least a portion of the dipole arms extends away from the loop antenna over a specified length, such that at least a portion of the dipole arms extends orthogonally along a z-axis away from the loop antenna over a different specified length, and such that at least a portion of the dipole arms bends back toward the loop antenna for a different specified length.

Example 9: The system of any of Examples 1-8, wherein the portion of the dipole arms that is bent back toward the loop antenna for a different specified length overlaps at least a portion of the loop antenna.

Example 10: A mobile electronic device may include a loop antenna and a dipole antenna that includes at least two dipole arms, wherein each of the at least two dipole arms is electrically connected to the loop antenna, and wherein the loop antenna comprises a balun for the dipole antenna.

Example 11: The mobile electronic device of Example 10, wherein the electrical connection between the loop antenna and the at least two arms of the dipole antenna create a combined loop-dipole, dual-wideband antenna.

Example 12: The mobile electronic device of Example 10 or Example 11, wherein the combined loop-dipole, dual-wideband antenna is tunable using at least one tuner that is electrically connected thereto.

Example 13: The mobile electronic device of any of Examples 10-12, wherein the combined loop-dipole, dual-wideband antenna is tunable between 5-7 GHz.

Example 14: The mobile electronic device of any of Examples 10-13, wherein the at least two dipole arms of the dipole antenna are electrically connected to the loop antenna along a two-dimensional plane.

Example 15: The mobile electronic device of any of Examples 10-14, wherein the at least two dipole arms of the dipole antenna are shaped such that at least a portion of the dipole arms extends away from the loop antenna over a specified length and such that at least a portion of the dipole arms bends toward the loop antenna for a different specified length.

Example 16: The mobile electronic device of any of Examples 10-15, wherein the at least two dipole arms of the dipole antenna are electrically connected to the loop antenna along a three-dimensional plane.

Example 17: The mobile electronic device of any of Examples 10-16, wherein the at least two dipole arms of the dipole antenna are shaped such that at least a portion of the dipole arms extends away from the loop antenna over a specified length, such that at least a portion of the dipole arms extends orthogonally along a z-axis away from the loop antenna over a different specified length, and such that at least a portion of the dipole arms bends back toward the loop antenna for a different specified length.

Example 18: The mobile electronic device of any of Examples 10-17, wherein the portion of the dipole arms that is bent back toward the loop antenna for a different specified length overlaps at least a portion of the loop antenna.

Example 19: An apparatus may include a loop antenna and a dipole antenna that includes at least two dipole arms, wherein each of the at least two dipole arms is electrically connected to the loop antenna, and wherein the loop antenna comprises a balun for the dipole antenna.

Example 20: The apparatus of Example 19, wherein the electrical connection between the loop antenna and the at least two arms of the dipole antenna create a combined loop-dipole, dual-wideband antenna that is tunable using at least one tuner that is electrically connected thereto.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

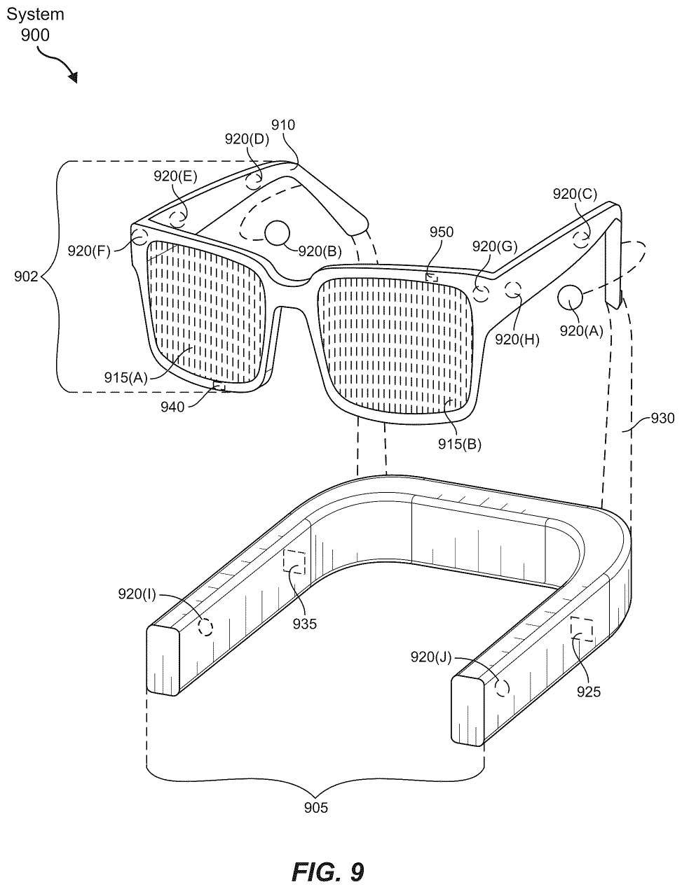

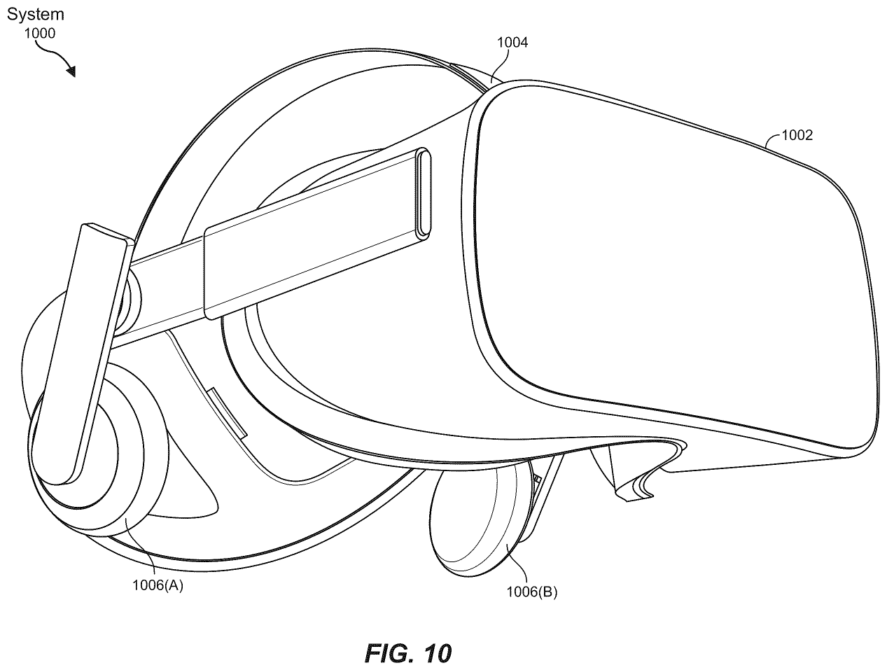

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 900 in FIG. 9) or that visually immerses a user in an artificial reality (such as, e.g., virtual-reality system 1000 in FIG. 10). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 9, augmented-reality system 900 may include an eyewear device 902 with a frame 910 configured to hold a left display device 915(A) and a right display device 915(B) in front of a user's eyes. Display devices 915(A) and 915(B) may act together or independently to present an image or series of images to a user. While augmented-reality system 900 includes two displays, embodiments of this disclosure may be implemented in augmented-reality systems with a single NED or more than two NEDs.

In some embodiments, augmented-reality system 900 may include one or more sensors, such as sensor 940. Sensor 940 may generate measurement signals in response to motion of augmented-reality system 900 and may be located on substantially any portion of frame 910. Sensor 940 may represent one or more of a variety of different sensing mechanisms, such as a position sensor, an inertial measurement unit (IMU), a depth camera assembly, a structured light emitter and/or detector, or any combination thereof. In some embodiments, augmented-reality system 900 may or may not include sensor 940 or may include more than one sensor. In embodiments in which sensor 940 includes an IMU, the IMU may generate calibration data based on measurement signals from sensor 940. Examples of sensor 940 may include, without limitation, accelerometers, gyroscopes, magnetometers, other suitable types of sensors that detect motion, sensors used for error correction of the IMU, or some combination thereof.

In some examples, augmented-reality system 900 may also include a microphone array with a plurality of acoustic transducers 920(A)-920(J), referred to collectively as acoustic transducers 920. Acoustic transducers 920 may represent transducers that detect air pressure variations induced by sound waves. Each acoustic transducer 920 may be configured to detect sound and convert the detected sound into an electronic format (e.g., an analog or digital format). The microphone array in FIG. 9 may include, for example, ten acoustic transducers: 920(A) and 920(B), which may be designed to be placed inside a corresponding ear of the user, acoustic transducers 920(C), 920(D), 920(E), 920(F), 920(G), and 920(H), which may be positioned at various locations on frame 910, and/or acoustic transducers 920(I) and 920(J), which may be positioned on a corresponding neckband 905.

In some embodiments, one or more of acoustic transducers 920(A)-(J) may be used as output transducers (e.g., speakers). For example, acoustic transducers 920(A) and/or 920(B) may be earbuds or any other suitable type of headphone or speaker.

The configuration of acoustic transducers 920 of the microphone array may vary. While augmented-reality system 900 is shown in FIG. 9 as having ten acoustic transducers 920, the number of acoustic transducers 920 may be greater or less than ten. In some embodiments, using higher numbers of acoustic transducers 920 may increase the amount of audio information collected and/or the sensitivity and accuracy of the audio information. In contrast, using a lower number of acoustic transducers 920 may decrease the computing power required by an associated controller 950 to process the collected audio information. In addition, the position of each acoustic transducer 920 of the microphone array may vary. For example, the position of an acoustic transducer 920 may include a defined position on the user, a defined coordinate on frame 910, an orientation associated with each acoustic transducer 920, or some combination thereof.

Acoustic transducers 920(A) and 920(B) may be positioned on different parts of the user's ear, such as behind the pinna, behind the tragus, and/or within the auricle or fossa. Or, there may be additional acoustic transducers 920 on or surrounding the ear in addition to acoustic transducers 920 inside the ear canal. Having an acoustic transducer 920 positioned next to an ear canal of a user may enable the microphone array to collect information on how sounds arrive at the ear canal. By positioning at least two of acoustic transducers 920 on either side of a user's head (e.g., as binaural microphones), augmented-reality system 900 may simulate binaural hearing and capture a 3D stereo sound field around about a user's head. In some embodiments, acoustic transducers 920(A) and 920(B) may be connected to augmented-reality system 900 via a wired connection 930, and in other embodiments acoustic transducers 920(A) and 920(B) may be connected to augmented-reality system 900 via a wireless connection (e.g., a BLUETOOTH connection). In still other embodiments, acoustic transducers 920(A) and 920(B) may not be used at all in conjunction with augmented-reality system 900.

Acoustic transducers 920 on frame 910 may be positioned in a variety of different ways, including along the length of the temples, across the bridge, above or below display devices 915(A) and 915(B), or some combination thereof. Acoustic transducers 920 may also be oriented such that the microphone array is able to detect sounds in a wide range of directions surrounding the user wearing the augmented-reality system 900. In some embodiments, an optimization process may be performed during manufacturing of augmented-reality system 900 to determine relative positioning of each acoustic transducer 920 in the microphone array.

In some examples, augmented-reality system 900 may include or be connected to an external device (e.g., a paired device), such as neckband 905. Neckband 905 generally represents any type or form of paired device. Thus, the following discussion of neckband 905 may also apply to various other paired devices, such as charging cases, smart watches, smart phones, wrist bands, other wearable devices, hand-held controllers, tablet computers, laptop computers, other external compute devices, etc.

As shown, neckband 905 may be coupled to eyewear device 902 via one or more connectors. The connectors may be wired or wireless and may include electrical and/or non-electrical (e.g., structural) components. In some cases, eyewear device 902 and neckband 905 may operate independently without any wired or wireless connection between them. While FIG. 9 illustrates the components of eyewear device 902 and neckband 905 in example locations on eyewear device 902 and neckband 905, the components may be located elsewhere and/or distributed differently on eyewear device 902 and/or neckband 905. In some embodiments, the components of eyewear device 902 and neckband 905 may be located on one or more additional peripheral devices paired with eyewear device 902, neckband 905, or some combination thereof.

Pairing external devices, such as neckband 905, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 900 may be provided by a paired device or shared between a paired device and an eyewear device, thus reducing the weight, heat profile, and form factor of the eyewear device overall while still retaining desired functionality. For example, neckband 905 may allow components that would otherwise be included on an eyewear device to be included in neckband 905 since users may tolerate a heavier weight load on their shoulders than they would tolerate on their heads. Neckband 905 may also have a larger surface area over which to diffuse and disperse heat to the ambient environment. Thus, neckband 905 may allow for greater battery and computation capacity than might otherwise have been possible on a stand-alone eyewear device. Since weight carried in neckband 905 may be less invasive to a user than weight carried in eyewear device 902, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 905 may be communicatively coupled with eyewear device 902 and/or to other devices. These other devices may provide certain functions (e.g., tracking, localizing, depth mapping, processing, storage, etc.) to augmented-reality system 900. In the embodiment of FIG. 9, neckband 905 may include two acoustic transducers (e.g., 920(I) and 920(J)) that are part of the microphone array (or potentially form their own microphone subarray). Neckband 905 may also include a controller 925 and a power source 935.

Acoustic transducers 920(I) and 920(J) of neckband 905 may be configured to detect sound and convert the detected sound into an electronic format (analog or digital). In the embodiment of FIG. 9, acoustic transducers 920(I) and 920(J) may be positioned on neckband 905, thereby increasing the distance between the neckband acoustic transducers 920(I) and 920(J) and other acoustic transducers 920 positioned on eyewear device 902. In some cases, increasing the distance between acoustic transducers 920 of the microphone array may improve the accuracy of beamforming performed via the microphone array. For example, if a sound is detected by acoustic transducers 920(C) and 920(D) and the distance between acoustic transducers 920(C) and 920(D) is greater than, e.g., the distance between acoustic transducers 920(D) and 920(E), the determined source location of the detected sound may be more accurate than if the sound had been detected by acoustic transducers 920(D) and 920(E).

Controller 925 of neckband 905 may process information generated by the sensors on neckband 905 and/or augmented-reality system 900. For example, controller 925 may process information from the microphone array that describes sounds detected by the microphone array. For each detected sound, controller 925 may perform a direction-of-arrival (DOA) estimation to estimate a direction from which the detected sound arrived at the microphone array. As the microphone array detects sounds, controller 925 may populate an audio data set with the information. In embodiments in which augmented-reality system 900 includes an inertial measurement unit, controller 925 may compute all inertial and spatial calculations from the IMU located on eyewear device 902. A connector may convey information between augmented-reality system 900 and neckband 905 and between augmented-reality system 900 and controller 925. The information may be in the form of optical data, electrical data, wireless data, or any other transmittable data form. Moving the processing of information generated by augmented-reality system 900 to neckband 905 may reduce weight and heat in eyewear device 902, making it more comfortable to the user.

Power source 935 in neckband 905 may provide power to eyewear device 902 and/or to neckband 905. Power source 935 may include, without limitation, lithium-ion batteries, lithium-polymer batteries, primary lithium batteries, alkaline batteries, or any other form of power storage. In some cases, power source 935 may be a wired power source. Including power source 935 on neckband 905 instead of on eyewear device 902 may help better distribute the weight and heat generated by power source 935.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 1000 in FIG. 10, that mostly or completely covers a user's field of view. Virtual-reality system 1000 may include a front rigid body 1002 and a band 1004 shaped to fit around a user's head. Virtual-reality system 1000 may also include output audio transducers 1006(A) and 1006(B). Furthermore, while not shown in FIG. 10, front rigid body 1002 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in augmented-reality system 900 and/or virtual-reality system 1000 may include one or more liquid crystal displays (LCDs), light emitting diode (LED) displays, microLED displays, organic LED (OLED) displays, digital light projector (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 900 and/or virtual-reality system 1000 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 900 and/or virtual-reality system 1000 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, bodysuits, handheld controllers, environmental devices (e.g., chairs, floor mats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A system comprising:
a loop antenna; and
a dipole antenna that includes at least two dipole arms,
wherein each of the at least two dipole arms is electrically connected to the loop antenna, and
wherein the loop antenna comprises a balun for the dipole antenna.

2. The system of claim 1, wherein the electrical connection between the loop antenna and the at least two arms of the dipole antenna create a combined loop-dipole, dual-wideband antenna.

3. The system of claim 2, wherein the combined loop-dipole, dual-wideband antenna is tunable using at least one tuner that is electrically connected thereto.

4. The system of claim 3, wherein the combined loop-dipole, dual-wideband antenna is tunable between 5-7 GHz.

5. The system of claim 1, wherein the at least two dipole arms of the dipole antenna are electrically connected to the loop antenna along a two-dimensional plane.

6. The system of claim 5, wherein the at least two dipole arms of the dipole antenna are shaped such that at least a portion of the dipole arms extends away from the loop antenna over a specified length and such that at least a portion of the dipole arms bends toward the loop antenna for a different specified length.

7. The system of claim 1, wherein the at least two dipole arms of the dipole antenna are electrically connected to the loop antenna along a three-dimensional plane.

8. The system of claim 7, wherein the at least two dipole arms of the dipole antenna are shaped such that at least a portion of the dipole arms extends away from the loop antenna over a specified length, such that at least a portion of the dipole arms extends orthogonally along a z-axis away from the loop antenna over a different specified length, and such that at least a portion of the dipole arms bends back toward the loop antenna for a different specified length.

9. The system of claim 8, wherein the portion of the dipole arms that is bent back toward the loop antenna for a different specified length overlaps at least a portion of the loop antenna.

10. A mobile electronic device comprising:
a loop antenna; and
a dipole antenna that includes at least two dipole arms,
wherein each of the at least two dipole arms is electrically connected to the loop antenna, and
wherein the loop antenna comprises a balun for the dipole antenna.

11. The mobile electronic device of claim 10, wherein the electrical connection between the loop antenna and the at least two arms of the dipole antenna create a combined loop-dipole, dual-wideband antenna.

12. The mobile electronic device of claim 11, wherein the combined loop-dipole, dual-wideband antenna is tunable using at least one tuner that is electrically connected thereto.

13. The mobile electronic device of claim 12, wherein the combined loop-dipole, dual-wideband antenna is tunable between 5-7 GHz.

14. The mobile electronic device of claim 10, wherein the at least two dipole arms of the dipole antenna are electrically connected to the loop antenna along a two-dimensional plane.

15. The mobile electronic device of claim 14, wherein the at least two dipole arms of the dipole antenna are shaped such that at least a portion of the dipole arms extends away from the loop antenna over a specified length and such that at least a portion of the dipole arms bends toward the loop antenna for a different specified length.

16. The mobile electronic device of claim 10, wherein the at least two dipole arms of the dipole antenna are electrically connected to the loop antenna along a three-dimensional plane.

17. The mobile electronic device of claim 16, wherein the at least two dipole arms of the dipole antenna are shaped such that at least a portion of the dipole arms extends away from the loop antenna over a specified length, such that at least a portion of the dipole arms extends orthogonally along a z-axis away from the loop antenna over a different specified length, and such that at least a portion of the dipole arms bends back toward the loop antenna for a different specified length.

18. The mobile electronic device of claim 17, wherein the portion of the dipole arms that is bent back toward the loop antenna for a different specified length overlaps at least a portion of the loop antenna.

19. An apparatus comprising:
a loop antenna; and
a dipole antenna that includes at least two dipole arms,
wherein each of the at least two dipole arms is electrically connected to the loop antenna, and
wherein the loop antenna comprises a balun for the dipole antenna.

20. The apparatus of claim 19, wherein the electrical connection between the loop antenna and the at least two arms of the dipole antenna create a combined loop-dipole, dual-wideband antenna that is tunable using at least one tuner that is electrically connected thereto.
